(19) United States
(12) Patent Application Publication
(10) Pub. No.: US 2018/0075542 A1
(43) Pub. Date: Mar. 15, 2018

(54) SPATIO-TEMPORAL DIFFUSION BASED RISK ASSESSMENT

(71) Applicant: International Business Machines Corporation, Armonk, NY (US)

(72) Inventors: Gabriel Asaftei, New York, NY (US); Kevin Chang, New York, NY (US); Raphael Ezry, New York, NY (US); Megan E. Foster, New York, NY (US); Munish Goyal, Yorktown Heights, NY (US)

(73) Assignee: International Business Machines Corporation, Armonk, NY (US)

(21) Appl. No.: 15/262,150

(22) Filed: Sep. 12, 2016

(51) Int. Cl. G06Q 50/00; G06T 11/20

(52) U.S. Cl. CPC G06Q 50/01; G06T 11/206

(57) ABSTRACT

A graph is constructing using a user node of a user and a set of connection nodes corresponding to connections in a social network of the user. The graph is overlaid on a risk map, which is a mapping of a geo-social risk characteristic of a geographical area. A first and a second risk indices are determined for a first and a second connection in the set of connections. Using the risk map, a first and a second risk diffusion boundary of the first and the second risk index are computed. When the first risk diffusion boundary includes the user node, a first risk contribution from the first connection node to the user node is computed using the first risk index. Using the first risk contribution, a risk index of the user is determined to accounts for a risk attributable to the user due to the user's social network.

### TECHNICAL FIELD

The present invention relates generally to a method, system, and computer program product for assessing a risk associated with a user. More particularly, the present invention relates to a method, system, and computer program product for spatio-temporal diffusion based risk assessment.

### BACKGROUND

An area in a three-dimensional geographical space is referred to as a geo-spatial area. Different geo-spatial areas have different geographical, demographic, economic, civic, law enforcement, social, and other types of characteristics associated therewith. Census data at various geographical levels—e.g., national census data, state census data, regional census data, city census data, and even neighborhood census data, are available and usable to determine these and other characteristics of geo-spatial areas.

Owing to the different characteristics of different geo-spatial areas, different geo-spatial areas also have different types and quantities of risks associated with them. For example, one geo-spatial area may have a higher risk of a traffic accident as compared to another geo-spatial area because of the difference in the states of the roads—and infrastructure characteristic—in the geo-spatial areas. One geo-spatial area may have a higher risk of a home foreclosures as compared to another geo-spatial area because of the difference in the economic characteristics in the geo-spatial areas. One geo-spatial area may have a higher risk of a law enforcement related disturbance as compared to another geo-spatial area because of the differences in the historical trends in the geo-spatial areas' civic and/or disturbance characteristics.

### SUMMARY

The illustrative embodiments provide a method, system, and computer program product. An embodiment includes a method that constructs a graph using a user node and a set of connection nodes, each connection node in the set of connection nodes corresponding to a connection in a social network of a user corresponding to the user node. The embodiment overlays the graph on a risk map, wherein the risk map is a mapping of a geo-social risk characteristic of a geographical area. The embodiment determines a first risk index of a first connection in the set of connections and a second risk index of a second connection in the set of connections. The embodiment computes, using a processor and a memory, using the risk map, a first risk diffusion boundary of the first risk index, and a second risk diffusion boundary of the second risk index. The embodiment computes, responsive to the first risk diffusion boundary including the user node, and using the first risk index, a first risk contribution from the first connection node to the user node. The embodiment computes, using the first risk contribution, a risk index of the user, wherein the risk index of the user accounts for a risk attributable to the user due to the social network of the user.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts an example visualization of socio-temporal risk contributions by geo-spatial areas of social network connections in accordance with an illustrative embodiment;

FIG. 4 depicts a block diagram of a configuration for spatio-temporal diffusion based risk assessment in accordance with an illustrative embodiment; and

FIG. 5 depicts a flowchart of an example process for spatio-temporal diffusion based risk assessment in accordance with an illustrative embodiment.

### DETAILED DESCRIPTION

The illustrative embodiments recognize that a type of risk associated with a geo-spatial area can translate into a geo-spatial area-related risk of a corresponding type to an individual living in or visiting the geo-spatial area. For example, when a person travels to a geo-spatial area of high traffic risk, the traffic-related risk associated with the person also increases. Similarly, when a person lives in a geo-spatial area where the risk of home foreclosures exceeds a threshold, a higher than a threshold risk of foreclosure is associated with the person.

The illustrative embodiments further recognize that the risks associated with a geo-spatial area have a temporal relationship as well. For example, the traffic conditions through a geo-spatial area may be worse in the day time as compared to the night time. Accordingly, traffic-related risk of the geo-spatial area—and therefore of a person living in or visiting the geo-spatial area—is also higher during the day time as compared to the night time.

A risk index of a person is a risk value computed by applying a function to a set of risk factors. The illustrative embodiments recognize that only some of the risk factors are attributed to the person's own characteristics, such as the person's own financial characteristics, driving characteristics, propensities, and historical actions. Presently, a risk index of a person is computed based on the risk factors are attributed to the person's own characteristics.

The illustrative embodiments recognize that some other risk factors are attributed to the person by the person's own geo-spatial area, i.e., the geo-spatial area in which the person lives or works. For example, a person who lives in an area of high traffic-congestion is likely to have a higher risk of traffic accident, as compared to another person who lives in a comparatively lower congestion area. Some presently available risk computation models use the risk factors associated with the person's own geo-spatial area in computing the person's risk index.

The illustrative embodiments further recognize that some other risk factors are attributed to the person's social circumstances. For example, a person has a social network of other people with whom the person is socially connected in some manner. As some non-limiting examples, a person has family members with whom the person may be very closely connected, e.g., via frequent communications, interactions, and/or visits; a person has a network of friends with whom the person may be closely connected, e.g., via regular communications, interactions, and/or visits; a person has business colleagues with whom the person may be regularly connected, e.g., via routine communications, interactions, and/or visits; a person has acquaintances with whom the person may be loosely connected, e.g., via infrequent communications, interactions, and/or visits; and so on.

A connection in a person's social network is another person. The illustrative embodiments recognize that a connection in a person's social network influences the person's risk index as well. For example, if the person visits the connection in the geo-spatial area where the connection lives or works, then the risk index of the connection—which is based on the characteristics of the geo-spatial area—add, reduce, or otherwise change the risk index of the person owing to the person's visit to the geo-spatial area due to the connection. For example, if the person frequently visits a friend who lives in a high traffic-congestion area, the risk of a traffic accident increases for the person.

As another example, if the person is related to the connection who lives in a geo-spatial area where the economic characteristics indicate a high risk of foreclosure, then the risk index of the connection—which is based on the characteristics of the geo-spatial area—add, reduce, or otherwise change the risk index of the person owing to the person's visit to the geo-spatial area due to the connection. For example, if the person has a relative who lives in a high foreclosure area, the risk that the person will suffer an adverse financial circumstance increases due to the increased possibility of the person having to undertake financial support or other financial responsibility for the relative.

The illustrative embodiments recognize that presently available risk index computation models fail to include connection-related influences on a person's risk index. Particularly, the illustrative embodiments recognize that present risk assessment models do not take into consideration the risk contributions of a person's social network, such as a connection's own risk index, and/or a characteristic of a geo-spatial area of a connection, with or without the consideration of a temporal relationship between the person and the connection's geo-spatial area.

The illustrative embodiments recognize that the presently available tools or solutions do not address these needs or provide adequate solutions for these needs. The illustrative embodiments used to describe the invention generally address and solve the above-described problems and other problems related to spatio-temporal diffusion based risk assessment.

An embodiment can be implemented as a software application. The application implementing an embodiment can be configured as a modification of an existing risk assessment model, as a separate application that operates in conjunction with an existing risk assessment model, a standalone application, or some combination thereof.

An embodiment receives a risk map of a geo-spatial area. For example, an existing geo-spatial mapping tool constructs a map of an area according to one or more types of risks associated with the area.

As a non-limiting example, one system uses the spatial or geographical features of an area to determine settlements and the socio-economic activities and structure among settled population in the area. From the determined activities and structure, the system determines the mapping of a variety of risks to the area. In some cases, the mapping of risks to a geo-spatial area is also usable to determine the pattern and rate of diffusion of various risks, such as the spread of weather hazard, mortgage risks, weather events such as floods, security, traffic or accidents etc. to other areas.

For a given time, the embodiment constructs a map of a user's social network according to the geographical locations of the connections in the social network. For example, the embodiment computes a graph in which the user and each connection in the user's social network is a node. Each node is placed or located at a geographical location on a geographical map. An edge connecting the user node to a connection node has a length that is indicative of a physical distance between a geographical location of the user and a geographical location of the connection. Note that the graph can change from time to time, because the user's social network can change from time to time as well.

An edge in the graph is further defined by a set of attributes. Some example attributes defining an edge include, a distance, which is indicative of a physical geographical distance between the location of the user and the location of the connection; a frequency or numerosity, which is indicative of a frequency of interactions, or a number of interactions over a period, between the user and the connection; a type of connection, which is indicative of a nature of the relationship between the user and the connection, e.g., family, friend, relative, coworker, acquaintance, etc.; a type of interaction, which is indicative of a manner in which interactions generally occur between the user and the connection, e.g., email, voice phone call, text messaging, participation in group messaging, social media posts or comments, etc.

These examples of attributes of an edge between a user node and a connection node in a social network graph are not intended to be limiting. From this disclosure, those of ordinary skill in the art will be able to conceive many other attributes and the same are contemplated within the scope of the illustrative embodiments.

An attribute of an edge influences whether or how a risk factor associated with the connection node, a risk characteristic associated with a geo-spatial area of the connection node, or both, affect the user node. For example, a traffic characteristic of the geo-spatial area of the connection node increases a risk of the user node according to a function of a number of visits by the user to the geo-spatial area of the connection over a period (a frequency attribute of the edge). For example, if the user visits the geo-spatial area daily, that risk contribution of the geo-spatial area to the user is much greater than if the user visits once a month.

Similarly, a flooding characteristic of the geo-spatial area of the connection node changes a risk of the user node according to a function of a type of interactions attribute of the edge. For example, the connection has a propensity for flooding that is associated with the geo-spatial area. If the user has personal meetings with the connection, the risk of the user getting caught in a flood is greater than if the user and the connection only interact via electronic communications.

These examples of attribute functions and the resulting risk contributions to the user are not intended to be limiting. From this disclosure, those of ordinary skill in the art will be able to conceive many other attribute functions and the risk contributions, and the same are contemplated within the scope of the illustrative embodiments.

Different connections in the user's social network have different weights. Some connections are more important, more close, or otherwise more significant for some reason than others. For example, a family member connection may be more significant from a risk contribution point of view than a social acquaintance on social media. As another example, a friend connection who lives in the next apartment may be more significant from a risk contribution point of view than a friend connection who lives on a different continent.

Depending on the type of risk factor being evaluated different connections have different weights. Furthermore, different geo-spatial areas are of different risk significance to the user at different times depending on the type of risk factor being evaluated. For example, a high traffic congestion geo-spatial area of a friend who lives on a different continent is probably not contributing any additional traffic risk to the user but is probably contributing a financial risk to the user if the user is likely to extend a loan to the friend because of the friend's geo-spatial area also having a high-foreclosure rate at the time when the user is interacting with the connection.

An embodiment computes a risk index of a connection node using the risk factors of the connection, the risk characteristics of the connection's geo-spatial area, and their corresponding weights at a time or duration of consideration. For example, a risk index of a connection is a function f_{c} of (a weight w, a risk factor r of a connection, a risk characteristic c of the connection's geo-spatial area, a time) for each risk factor and risk characteristic considered.

A risk of a connection node diffuses from the geo-spatial area to other areas, such as an area of the user node according to a risk diffusion function. An embodiment determines a risk effect experienced by the user node from a diffusion of a risk index of a connection. For example, the risk contribution experienced by the user node at the user node's geo-spatial area due to a risk index of a connection at the connection node's geo-spatial area is F(f_{c}).

An embodiment defines a risk diffusion area around the user node on the graph. The risk diffusion area includes a subset of the connection nodes such that the risk contributions to the user node due to the diffusion from each connection node in the subset exceeds a threshold contribution.

The embodiment computes a risk index of the user using the risk contributions from the subset of connections within the risk diffusion area. This risk index of the user now accounts for the spatio-temporal risks contributed by the user's social network connections and their geo-spatial areas.

The risk index computed by an embodiment can be recomputed from time to time, as the user's social network changes, as the user's interactions with the social network change, a risk factor of a connection changes, a risk characteristic of a connection's geo-spatial area changes, or some other changes occur in the user's social network to justify a re-evaluation. The risk index computed by the embodiment can be combined with another risk index computed by a presently available risk assessment tool to create a complete risk profile of the user.

The manner of spatio-temporal diffusion based risk assessment described herein is unavailable in the presently available methods. A method of an embodiment described herein, when implemented to execute on a device or data processing system, comprises substantial advancement of the functionality of that device or data processing system in creating a complete risk profile of the user which includes a user's own risk factors and the risk characteristics of the user's geo-spatial area but also the risks contributed by the user's social network and the geo-spatial areas of the connections in that social network.

The illustrative embodiments are described with respect to certain types of risk factors, risk characteristics, geo-spatial areas, social networks, types of connections, types of interactions, indices, weights, contributions, functions, computations, thresholds, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

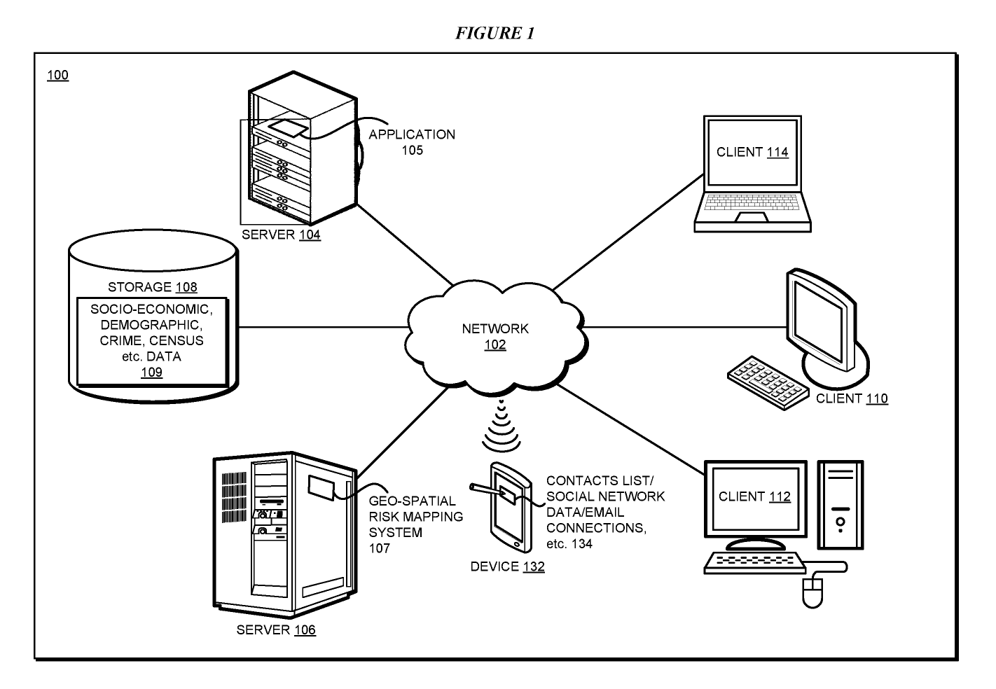

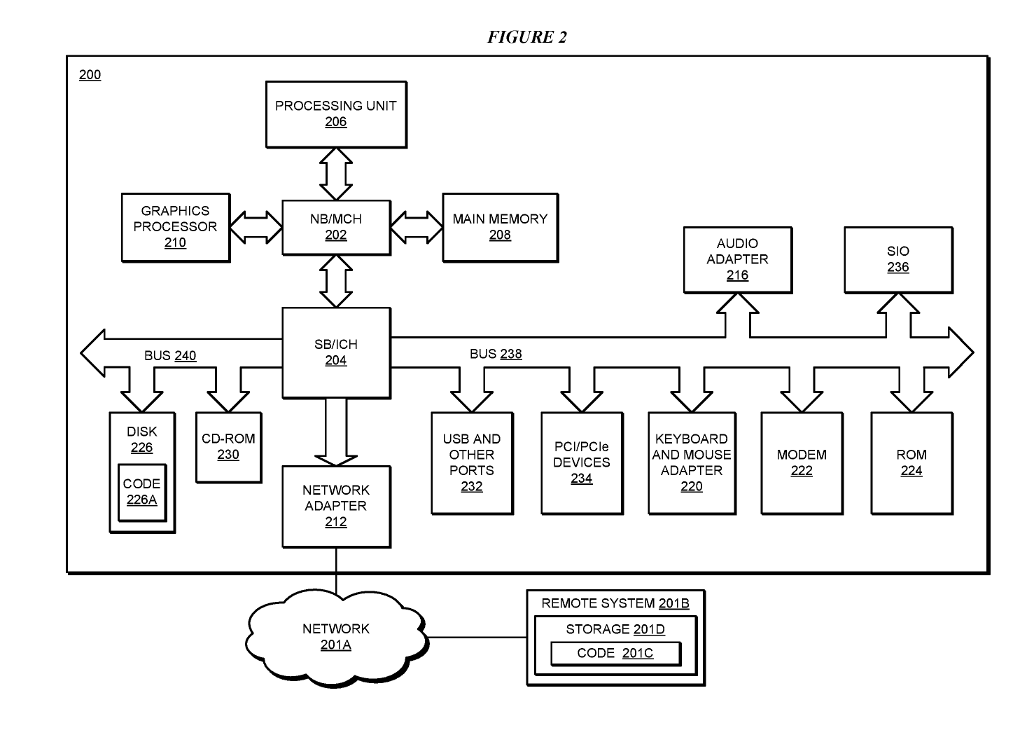

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Geo-spatial risk mapping system 107 uses data 109 to produce a risk map of geographical areas for a variety of risk factors. Data 109 includes socio-economic data, demographic data, law enforcement data, and other types of data available from a variety of census and other data sources. Device 132 is a device of any suitable type used by a user to interact with the user's social network. Device 132 includes social network information 143. Social network information 134 can include but is not limited to contacts list, social network connections data, text messaging contacts, instant messaging contacts, email connections, and the like. Application 105 uses information 134 and the risk map output of system 107 to compute a risk index of the user of device 132.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

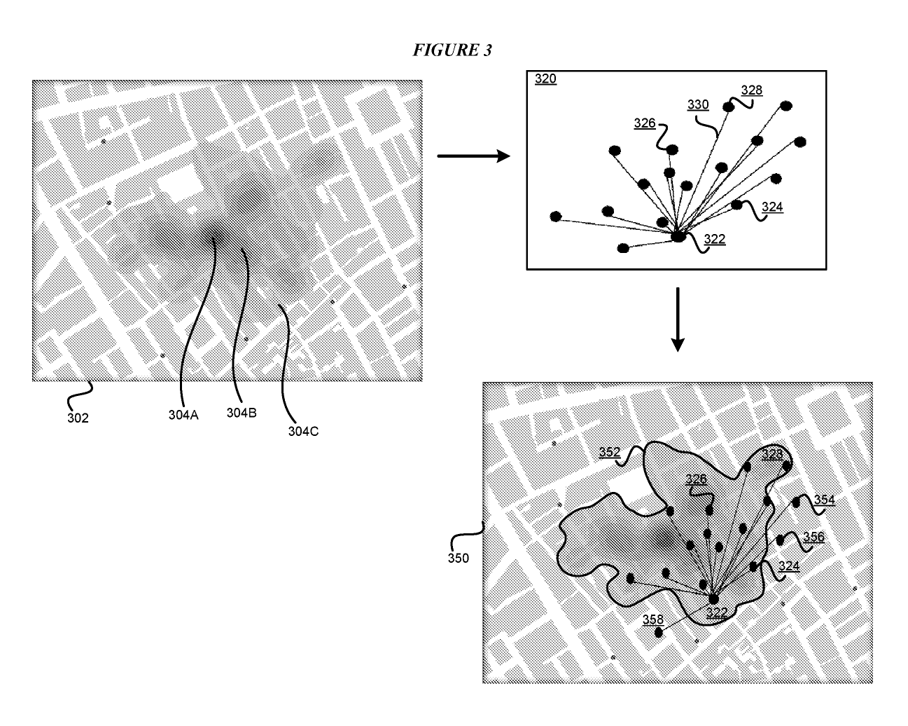

With reference to FIG. 3, this figure depicts an example visualization of socio-temporal risk contributions by geo-spatial areas of social network connections in accordance with an illustrative embodiment. Map 302 is constructed and provided by geo-spatial risk mapping system 107 in FIG. 1. Graph 320 is constructed from information 134 in FIG. 1 by application 105 in FIG. 1. Overlay 350 is used by application 105 in FIG. 1 to compute a social-temporal risk contribution to a user in a manner described herein.

Consider geo-spatial area 304A in map 302. Geo-spatial area 304A is depicted to cover a portion of map 302. A color (grayscale shade) of area 304A depicts a level of a particular risk in are 304A, as computed from data 109 by system 107 in FIG. 1. Area 304B is a diffusion area of geo-spatial area 304A, wherein the risk of area 304A is diffused or spread. Area 304B is larger relative to area 304A, and has a different—diffused—risk level of the particular risk for which areas 304A and 304B are shaded or colored. The different shade or color in area 304B is indicative of the different risk level in area 304B relative to area 304A. Similarly, are 304C is another area larger than area 304B, and having a further diffused risk level of the risk in geo-spatial area 304A.

Any number of diffusion areas can similarly be computed and mapped on map 302. As depicted, only one example geo-spatial area is shown with the corresponding risk levels at different locations suitably colored or shaded.

Graph 320 is a graph of a social network of a user as described herein. The user is represented in graph 320 as user node 322. Each connection in the user's social network is represented by a connection node, e.g., nodes 324, 326, and 328. An edge between the user and a connection, e.g., edge 330 between user node 322 and connection node 328, has a set of attributes associated therewith, in a manner described herein.

Application 105 overlays graph 320 on map 302 to construct overlay 350. Overlay 350 shows the diffused risks of various geo-spatial areas on the location of user node 322.

Area 352 is a risk diffusion area that includes or overlaps user node 322. The boundary of risk diffusion area denotes a threshold amount of risk contributed by the risk characteristic of the underlying geo-spatial area. Different geo-spatial areas and different risk characteristics of each geo-spatial area can potentially have different risk diffusion areas.

Now assume that risk diffusion area 352 is the common risk diffusion area of all such different risk diffusion areas where the risk contribution exceeds the threshold. As can be seen in this non-limiting example, risk diffusion area 352 includes some connection nodes and excludes certain other connection nodes. For example, connection nodes 324, 326, and 328 lie within risk diffusion area 452 and therefore are regarded as contributing greater than a threshold amount of risk to user node 322. Connection nodes 354, 356, and 358 lie outside risk diffusion area 352 and contribute less that a threshold amount of risk to user node 322.

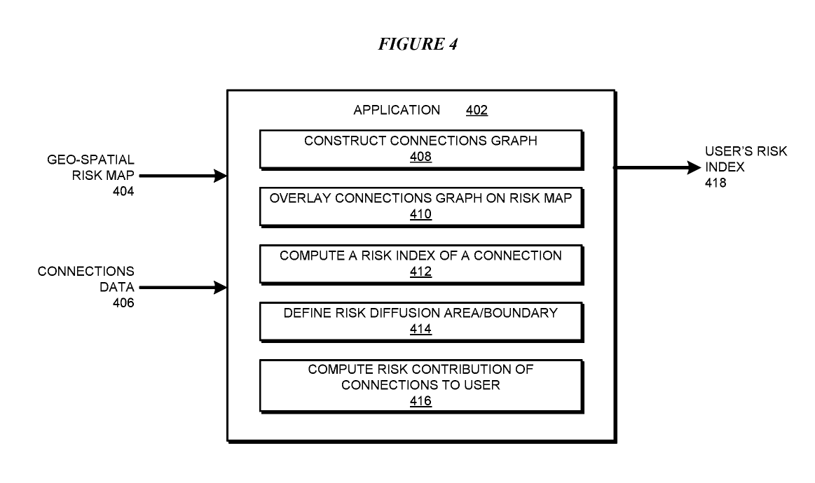

With reference to FIG. 4, this figure depicts a block diagram of a configuration for spatio-temporal diffusion based risk assessment in accordance with an illustrative embodiment. Application 402 is an example of application 105 in FIG. 1. Geo-spatial risk map input 404 is an example of map 302 in FIG. 3. Connections data 406 is an example of information 134 in FIG. 1.

Component 408 constructs a connections graph, such as graph 320 in FIG. 3. Component 410 overlays the connections graph on the risk map. Component 412 computes a risk index of each connection in the connections graph. Component 414 determines the risk diffusion areas relative to each connection node to identify those risk diffusion areas which overlap the user node at greater than a threshold amount of risk.

Component 416 computes a unified risk diffusion area relative to the user using the risk contributions from all such connection nodes whose risk diffusion areas overlap the user node at greater than a threshold amount of risk. Component 416 computes a user's risk index using the risk contributions from all the connections that are participating in the unified risk diffusion area. Component 416 outputs user's risk index 418 that results from such computation in a manner described herein.

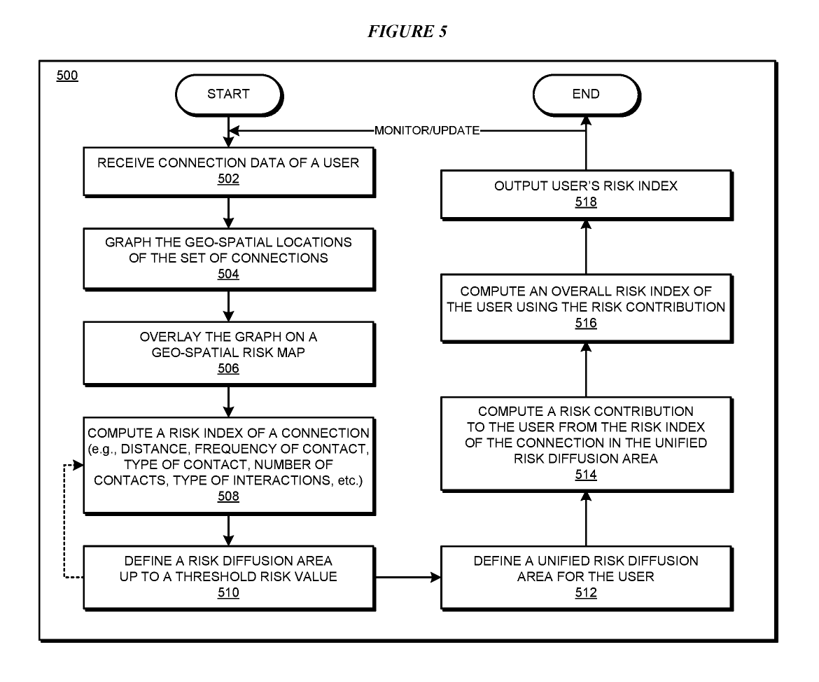

With reference to FIG. 5, this figure depicts a flowchart of an example process for spatio-temporal diffusion based risk assessment in accordance with an illustrative embodiment. Process 500 can be implemented in application 402 in FIG. 4.

The application receives connection data, e.g., connection data 134 in FIG. 1, from a user (block 502). The application constructs a graph of nodes and edges, such as graph 320 in FIG. 3, using the geo-spatial locations of each user-connection node pair (block 504). The application overlays the graph on a geo-spatial risk map, e.g., on risk map 302 in FIG. 3 (block 506).

The application computes a risk index of a connection in the graph, e.g., based on a distance from the user, frequency of interactions with the user, a type of contact, a number of interactions, a type of interactions, and other factors as described herein (block 508). The application defines a risk diffusion area for each connection's risk index (block 510). For example, given a connection with a risk index computed in block 508, at block 510, the application computes a risk diffusion area up to the boundary where the risk index of the connection diffuses to the threshold risk value.

The application repeats blocks 508 and 510 for a set of connections. For example, certain connections may be omitted for the risk diffusion computation for certain types of risks as described herein.

The application defines a unified risk diffusion area around the user, or otherwise relative to the user in which some of the risk indices of some of the connections are still contributing a greater than a threshold amount of risk to the user (block 512). The application computes a risk contribution to the user from the risk index of each connection remaining in the unified risk diffusion area of the user (block 514). Using the risk contributions, the application computes an overall risk index of the user (block 516). The application outputs the user's risk index (block 518).

The application may end process 500 thereafter. Alternatively, the application monitors the changes in the social network, the geo-spatial areas of the connections, changing risk factors and characteristics, etc., as described herein. The application updates the risk index of the user depending on the changes observed during the monitoring by repeating process 500 or a portion thereof with the changed values.

Thus, a computer implemented method, system or apparatus, and computer program product are provided in the illustrative embodiments for spatio-temporal diffusion based risk assessment and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
constructing a graph using a user node and a set of connection nodes, each connection node in the set of connection nodes corresponding to a connection in a social network of a user corresponding to the user node;
overlaying the graph on a risk map, wherein the risk map is a mapping of a geo-social risk characteristic of a geographical area;
determining a first risk index of a first connection in the set of connections and a second risk index of a second connection in the set of connections;
computing, using a processor and a memory, using the risk map, a first risk diffusion boundary of the first risk index, and a second risk diffusion boundary of the second risk index;
computing, responsive to the first risk diffusion boundary including the user node, and using the first risk index, a first risk contribution from the first connection node to the user node; and
computing, using the first risk contribution, a risk index of the user, wherein the risk index of the user accounts for a risk attributable to the user due to the social network of the user.

2. The method of claim 1, further comprising:
excluding, responsive to the second risk diffusion boundary not including the user node, the second connection node from the computing of the risk index to the user node.

3. The method of claim 1, wherein the first risk diffusion boundary is computed from a first geographical location of the first connection node, and wherein the second risk diffusion boundary is computed from a second geographical location of the second connection node.

4. The method of claim 1, further comprising:
defining a threshold risk value, wherein the first risk index achieves the threshold risk value at the first risk diffusion boundary.

5. The method of claim 1, wherein the first risk index of the first connection is a function of a frequency of interactions between the user and the first connection.

6. The method of claim 1, wherein the first risk index of the first connection is a function of a type of interactions between the user and the first connection.

7. The method of claim 1, wherein the first risk index of the first connection is a function of a type of relationship between the user and the first connection.

8. The method of claim 1, wherein the geographical area of the risk map includes at least a subset of the connections.

9. The method of claim 1, further comprising:
configuring, in the graph, an edge between the user node and a selected connection node, the edge having a length that is indicative of a geographical distance between a geographical location of the user and a geographical location of the selected connection.

10. The method of claim 1, further comprising:
configuring, in the graph, an edge between the user node and a selected connection node, the edge having a set of attributes, an attribute in the set of attributes being indicative of a frequency of interactions between the user and the selected connection.

11. The method of claim 1, further comprising:
configuring, in the graph, an edge between the user node and a selected connection node, the edge having a set of attributes, an attribute in the set of attributes being indicative of a type of relationship between the user and the selected connection.

12. The method of claim 1, further comprising:
configuring, in the graph, an edge between the user node and a selected connection node, the edge having a set of attributes, an attribute in the set of attributes being indicative of a type of interactions between the user and the selected connection.

13. The method of claim 1, wherein the first risk contribution from the first connection node to the user node is computed responsive to a temporal factor, wherein the temporal factor is a risk factor associated with the first connection at a given time.

14. The method of claim 1, wherein the first risk contribution from the first connection node to the user node is computed responsive to a temporal factor, wherein the temporal factor is a risk factor associated with the geographical location of the first connection at a given time.

15. A computer usable program product comprising one or more computer-readable storage devices, and program instructions stored on at least one of the one or more storage devices, the stored program instructions comprising:
program instructions to construct a graph using a user node and a set of connection nodes, each connection node in the set of connection nodes corresponding to a connection in a social network of a user corresponding to the user node;
program instructions to overlay the graph on a risk map, wherein the risk map is a mapping of a geo-social risk characteristic of a geographical area;
program instructions to determine a first risk index of a first connection in the set of connections and a second risk index of a second connection in the set of connections;
program instructions to compute, using a processor and a memory, using the risk map, a first risk diffusion boundary of the first risk index, and a second risk diffusion boundary of the second risk index;
program instructions to compute, responsive to the first risk diffusion boundary including the user node, and using the first risk index, a first risk contribution from the first connection node to the user node; and
program instructions to compute, using the first risk contribution, a risk index of the user, wherein the risk index of the user accounts for a risk attributable to the user due to the social network of the user.

16. The computer usable program product of claim 15, further comprising:
program instructions to exclude, responsive to the second risk diffusion boundary not including the user node, the second connection node from the computing of the risk index to the user node.

17. The computer usable program product of claim 15, wherein the first risk diffusion boundary is computed from a first geographical location of the first connection node, and wherein the second risk diffusion boundary is computed from a second geographical location of the second connection node.

18. The computer usable program product of claim 15, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct a graph using a user node and a set of connection nodes, each connection node in the set of connection nodes corresponding to a connection in a social network of a user corresponding to the user node;
program instructions to overlay the graph on a risk map, wherein the risk map is a mapping of a geo-social risk characteristic of a geographical area;
program instructions to determine a first risk index of a first connection in the set of connections and a second risk index of a second connection in the set of connections;
program instructions to compute, using a processor and a memory, using the risk map, a first risk diffusion boundary of the first risk index, and a second risk diffusion boundary of the second risk index;
program instructions to compute, responsive to the first risk diffusion boundary including the user node, and using the first risk index, a first risk contribution from the first connection node to the user node; and
program instructions to compute, using the first risk contribution, a risk index of the user, wherein the risk index of the user accounts for a risk attributable to the user due to the social network of the user.
